(19) United States
(12) Patent Application Publication
(10) Pub. No.: US 2026/0341034 A1
(43) Pub. Date: Oct. 29, 2026

(54) VISION SYSTEM FOR A VEHICLE

(71) Applicant: Motherson Innovations Company Limited, London (GB)

(72) Inventors: Philipp Schau, Stuttgart (DE); Mariusz Madry, Stuttgart (DE)

(21) Appl. No.: 19/655,109

(22) Filed: Apr. 22, 2026

(30) Foreign Application Priority Data
Apr. 23, 2025 (DE) 102025115633.6

(51) Int. Cl. G06V 20/56; G06F 9/50

(52) U.S. Cl. CPC G06V 20/56; G06F 9/5094

(57) ABSTRACT

The present disclosure provides a vision system comprising an image capturing device and a processor. The image capturing device is configured to capture images and the processor is configured to perform at least one function, to process the images captured by the image capturing device. The system further comprises a temperature detection unit which is configured to detect the temperature of the processor and provide temperature data to a control unit. The control unit is configured to receive the temperature data containing the detected temperature and controls the at least one function performed by the processor based on the temperature data.

### CROSS-REFERENCE TO RELATED APPLICATIONS

This application claims the benefit of priority to German Patent Application DE 10 2025 115 633.6, filed on Apr. 23, 2025, which is incorporated herein by reference in its entirety.

### BACKGROUND

The present disclosure relates to a vision system for a vehicle. Particularly, the present disclosure relates to control temperature of a processor within the vision system.

A vision system is employed in a vehicle for various purposes such as monitoring surroundings, vehicular entrance monitoring, driver attributes monitoring and other. In order to monitor, the vision system has an image capturing device which runs on algorithms, the system thus having system chips and processor. During the process of capturing images of interior and/or exterior surrounding, the processor processes the captured images which in turn raises the temperature of the processor, thereby impacting the performance of the processor.

EP4301626A4 describes a vehicular interior rearview mirror assembly including a mirror head having an interior mirror reflective element. The interior mirror reflective element has a mirror transflector that transmits near-IR light incident thereon, transmits visible light incident thereon and reflects visible light incident thereon. The mirror assembly includes a camera disposed within the mirror head and viewing through the mirror transflector. The patent document discloses that the heat management can be achieved by entering throttle modes, which reduce power consumption by lowering the algorithm feature sets, clock frequency, or frame rate.

EP3971049B1 describes an automated driving system comprising: an automation control module for controlling one or more driving functions of a vehicle; a safety control module for determining one or more operating conditions relevant to the safety performance of the vehicle. The automation control module is configured to automatically change the speed of the vehicle to a reduced speed based on the one or more operating conditions determined by the safety control module.

Above-mentioned prior arts fail to solve the problem of controlling a temperature of the processor by controlling functions performed by the processor.

### SUMMARY

Against the background, it is an object of the present disclosure to provide an improved and cost effective vision system in which temperature of the processor can be controlled effectively.

At least one of these objects is achieved by a vision system having the features of claim 1 and/or by a vehicle having the features of claim 12.

In an embodiment, the vision system comprises an image capturing device and a processor. The image capturing device is configured to capture images and the processor is configured to perform at least one function to process the images captured by the image capturing device. The system further comprises a temperature detection unit configured to detect a temperature of the processor and provide temperature data to a control unit. The control unit is configured to receive the temperature data containing the temperature of the processor detected by the temperature detection unit and control the at least one function performed by the processor based on the temperature data.

In an embodiment, the control unit is configured to turn OFF at least one function performed by the processor in an event when the detected temperature of the processor is above a threshold range.

In an embodiment, the at least one function performed by the processor is configured to be a framerate reduction, software algorithms, transition filters, or chromatic aberration correction.

In an embodiment, the control unit is configured to turn ON at least one function performed by the processor in an event when the detected temperature of the processor is below the threshold range.

In an embodiment, the threshold range is about 85%-95% of operating temperature of the processor. More preferably, the threshold range is about 75%-85%, more preferably about 65%-75%, or more preferably about 55%-65% of the operating temperature.

In an embodiment, the control unit is configured to control the at least one function performed by the processor based on at least one vehicle parameter, in particular; speed, steering angle, and/or parking maneuvering of the vehicle during day and night conditions.

According to another aspect of the present disclosure, a method of controlling a temperature in a vision system for a vehicle is disclosed. The method comprises steps of: capturing, images by an image capturing device; processing, by a processor, the images captured; detecting, by a temperature detecting unit, a temperature of the processor to provide temperature data to a control unit; receiving, by a control unit, the temperature data containing the temperature of the processor detected by the temperature detection unit; and controlling, by the control unit, at least one function performed by the processor based on the temperature data.

In an embodiment, the step of controlling, by the control unit, comprises turning OFF the at least one function performed by the processor in an event when the detected temperature of the processor is above a threshold range.

In an embodiment, the step of controlling by the control unit, further comprises turning ON the at least one function performed by the processor in an event when the detected temperature of the processor is below a threshold range.

The present disclosure is also related to a vehicle with a vision system as described above.

The vision system of the present disclosure is cost effective and is configured to efficiently manage the temperature of the processor by controlling the at least one function performed by the processor such as turning ON and/or OFF the at least one function in particular: framerate reduction, software algorithms, transition filters, or chromatic aberration correction. Further, the vision system may be configured to be used in different type of vehicles.

It should be noted that the features set out individually in the following description can be combined with each other in any technically advantageous manner and set out other forms of the present disclosure. It should be understood, however, that the disclosure is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the disclosure. The figures are not necessarily drawn to scale. Like numbers used in the figures refer to like components. However, it will be understood that the use of a number to refer to a component in a given figure is not intended to limit the component in another figure labelled with the same number. The description further characterizes and specifies the present disclosure in particular in connection with the figures.

### BRIEF DESCRIPTION OF THE DRAWINGS

Other aspects, advantages, and salient features of the present disclosure will become apparent to those skilled in the art from the following detailed description, which taken in conjunction with the annexed drawings, discloses exemplary embodiments of the disclosure, wherein:

FIG. 1 illustrates a block diagram of a vision system according to an embodiment of the present disclosure; and

FIG. 2 illustrates steps of a method of controlling a temperature in the vision system according to an embodiment of the present disclosure.

### DETAILED DESCRIPTION

The foregoing objects, features and advantages of the present disclosure will become more apparent from the following detailed description related to the accompanying drawings. However, various modifications may be applied to the present disclosure, and the present disclosure may have various embodiments of the present disclosure. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, reference signs designate elements throughout the specification. In the following description, the same reference signs are used to designate elements, which have the same function within the same idea illustrated in the drawings of each embodiment of the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “outer”, “inner”, “left”, “right”, “vertical”, “horizontal”, etc. may relate to one or more particular components as seen generally from a user's vantage point during use or operation, and such terms and/or phrases are not to be interpreted as limiting, but merely as a representative basis for describing the disclosure to one skilled in the art. In addition, a suffix “region”, “part”, “unit” for a component used in the following description are given or mixed in consideration of only the ease of writing the specification, and do not have meanings or roles distinguished from each other.

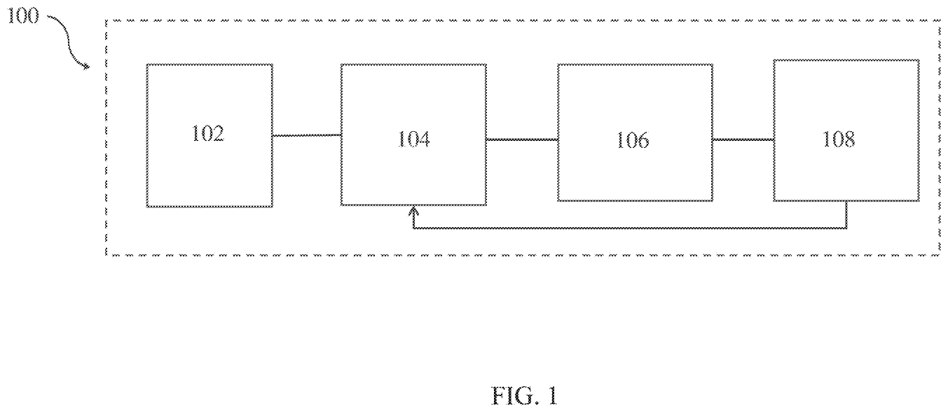

FIG. 1 shows a block diagram of a vision system 100 in accordance with aspects of the present disclosure. In an embodiment, the vision system 100 comprises an image capturing device 102 and a processor 104. The image capturing device 102 is configured to capture images and the processor 104 is configured to perform at least one function to process the images captured by the image capturing device 102. The system 100 also comprises a temperature detection unit 106, and a control unit 108. The temperature detection unit 106 is configured to detect a temperature of the processor 104 and provide temperature data to the control unit 108. The control unit 108 is configured to receive the temperature data containing the detected temperature by the temperature detecting unit 106 and control the at least one function performed by the processor 104 based on the temperature data.

In further embodiment, the processor 104 may be provided as an internal unit of the image capturing device 102.

In a further embodiment, the control unit 108 is configured to have a prestored threshold range of the temperature of the processor 104. In an embodiment, the threshold range is about 85%-95% of operating temperature of the processor 104. More preferably, the threshold range is about 75%-85%, more preferably about 65%-75%, or more preferably about 55%-65% of the operating temperature.

In an event, if the temperature of the processor 104 detected by the temperature detection unit 106 is above the threshold range, the control unit 108 controls the temperature by turning OFF the at least one function performed by the processor 104.

In an embodiment, when the temperature detection unit 106 detects that the temperature of the processor 104 is below the threshold range, the control unit 108 is configured to turn ON the at least one function performed by the processor 104.

In an example, the threshold range of 85%-95% has an upper threshold value 95% and a lower threshold value 85%. When the operating temperature of the processor 104 rises above the upper threshold value which is set at 95%, the control unit 108 is configured to turn OFF the at least one of the functions performed by the processor 104. This precautionary action is taken to prevent potential overheating and damage to the processor 104, ensuring its longevity and reliability.

Once the at least one function performed by the processor 104 is turned OFF, it remains inactive as long as the temperature of the processor 104 stays above the lower threshold value 85%. Therefore, the lower threshold value acts as a critical point, indicating that the processor 104 is still at risk of overheating if it is not cooled down. The control unit 108 continuously monitors the temperature by means of the temperature detection unit 106, and only when the operating temperature of the processor 104 falls below the lower threshold value of 85%, the control unit 108 turns ON the previously disabled the at least one function performed by the processor 104. This mechanism ensures that the processor 104 operates safely within its threshold range, thus maintaining optimal performance and preventing thermal-related failures of the processor 104.

In an embodiment, the at least one function is configured to be a framerate reduction, software algorithms, transition filters, or chromatic aberration correction. In particular, the control unit 108 is configured to control the temperature of the processor 104 by turning ON and OFF the chromatic aberration correction function of the processor 104.

In an embodiment, the processor 104 may encompass a variety of advanced computational architectures designed to handle specific processing tasks efficiently. This may include image signal processors (ISP), which are specialized for managing image data and enhancing visual quality, particularly in imaging applications such as cameras and video systems. Additionally, the processor 104 may utilize digital signal processors (DSP), which are optimized for high-speed numerical calculations and are commonly employed in audio, video, telecommunications, and other signal processing applications. Furthermore, the processor could also be a system-on-a-chip (SoC), which integrates a complete system of multiple components, including the CPU, memory, peripherals, and sometimes even dedicated ISPs or DSPs, all on a single chip.

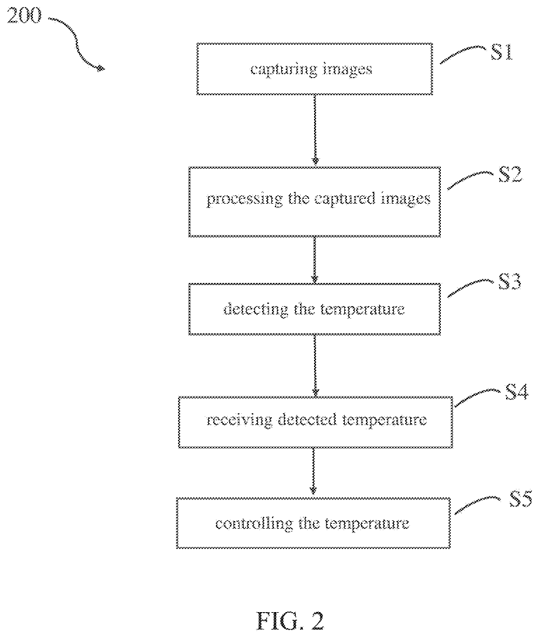

In another embodiment, a method 200 of controlling a temperature in the vision system 100 is disclosed in FIG. 2. The method 200 comprises step S1 of capturing, images by an image capturing device 102. The images captured are processed in step S2, by the processor 104. In step S3, a temperature of the processor 104 is detected by a temperature detection unit 106 to provide temperature data to a control unit 108. In step S4, the control unit 108 receives the temperature data containing the detected temperature and in step S5, the control unit 108 controls at least one function performed by the processor 104 based on the temperature data.

In an embodiment, when the temperature detection unit 106 detects that the temperature of the processor 104 is above the threshold range, the control unit 108 is configured to turn OFF the at least one function performed by the processor 104. In an event the temperature detection unit 106 detects that the temperature of the processor 104 is below the threshold range, the control unit 108 is further configured to turn ON the at least one function performed by the processor 104.

In an embodiment, the at least one function is any one of framerate reduction, software algorithms, transition filters, and/or chromatic aberration correction function.

Chromatic aberration is a prevalent optical issue encountered by image-capturing devices, such as digital cameras, microscopes, and telescopes. It arises due to the variation in the refractive index (n) of a lens with respect to different wavelengths of light, which in turn affects the focal length (f). Since shorter wavelengths (e.g., blue light) are refracted more strongly than longer wavelengths (e.g., red light), the lens focuses them at different points, preventing all colors in the optical spectrum from converging at a single focal plane. This phenomenon leads to image distortions, typically manifesting as color fringing around objects.

The processor 104 of the vision system is configured to perform chromatic aberration correction function in order to improve the quality of the images. However, a lot of heat may be generated by the processor 104 while the chromatic aberration correction function is running to counter the chromatic aberration for the captured images by various algorithms, thereby leading to rise in temperature in the processor 104 which may further reduce the overall efficiency of the processor 104.

In an embodiment, the control unit 108 is configured to control the at least one function performed by the processor 104 based on at least one vehicle parameter, in particular speed, steering angle, and/or parking maneuvering of the vehicle during day and night conditions.

In one embodiment, when the vehicle is traveling at high speeds on a highway during daylight, the images captured by the image-capturing device 102 may suffer from motion blur, lens distortions, and environmental interferences such as glare or reflections. These factors can reduce the clarity and sharpness of the captured images. Similarly, at night, the image quality may degrade due to low ambient light, requiring chromatic aberration correction to enhance clarity and color accuracy.

To compensate for these optical distortions, the processor 104 applies chromatic aberration correction. This process involves computational techniques that analyze and adjust color shifts and fringing effects in the captured images. However, executing these corrections requires significant processing power, which can generate additional heat within the processor 104. This heat buildup can be exacerbated under prolonged high-speed driving conditions during the day or extended low-light operations at night.

To prevent potential overheating and ensure the reliability of the processor 104, the temperature detection unit 106 continuously monitors the temperature of the processor 104. If the detected temperature surpasses a threshold range, the control unit 108 disables the chromatic aberration correction function performed by the processor 104. This measure helps to regulate the temperature and prevent potential damage or degradation of the performance of the processor 104.

By dynamically managing the chromatic aberration correction based on thermal conditions, the system balances image quality enhancement with hardware longevity, ensuring stable and efficient operation of the processor 104 under varying environmental and driving conditions.

In one embodiment, when the vehicle is being driven in a city environment during the daytime, it is typically moving at lower speeds due to factors such as traffic signals, pedestrian crossings, and congestion. Under these conditions, the images captured by the image capturing device 102 generally exhibit less motion blur and fewer distortions compared to high-speed highway driving. As a result, the need for extensive chromatic aberration correction may be reduced since the processor 104 experience fewer optical challenges.

Additionally, the reduced computational workload associated with chromatic aberration correction in city driving conditions leads to lower power consumption and, consequently, less heat generation within the processor 104. Since the temperature remains below the threshold range, there is no risk of overheating. Under these stable thermal conditions, the control unit 108 may allow the chromatic aberration correction function to be performed by the processor 104 to remain active.

By selectively managing the activation of chromatic aberration correction based on driving conditions, the system optimizes both image quality and thermal efficiency. This adaptive approach ensures that high-quality images are captured when necessary while preventing unnecessary processing that could contribute to overheating, thereby enhancing the longevity and reliability of the processor 104.

Although the subject matter of the present disclosure has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims. i.e. the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

### REFERENCE SIGNS LIST

100 Vision system
102 Image capturing device
104 Processor
106 Temperature detection unit
108 Control unit

What is claimed is:

1. A vision system for a vehicle, the vision system comprising:
an image capturing device configured to capture images;
a processor configured to perform at least one function to process images captured by the image capturing device;
a temperature detection unit configured to detect a temperature of the processor and provide temperature data; and
a control unit configured to:
receive the temperature data containing the detected temperature by the temperature detection unit; and
control the at least one function performed by the processor based on the temperature data.

2. The vision system according to claim 1, wherein the control unit is configured to turn OFF at least one function performed by the processor in an event when the detected temperature of the processor is above a threshold range.

3. The vision system according to claim 1, wherein the at least one function of the processor is configured to be a framerate reduction, software algorithms, transition filters, or chromatic aberration correction.

4. The vision system according to claim 1, wherein the control unit is configured to turn ON at least one function performed by the processor in an event when the detected temperature of the processor is below the threshold range.

5. The vision system according to claim 2, wherein the threshold range is about 85% 95% of operating temperature of the processor.

6. The vision system according to claim 2, wherein the threshold range is about 75% 85%, more preferably about 65%-75% or more preferably about 55%-65% of the operating temperature.

7. The vision system according to claim 1, wherein the control unit is configured to control the at least one function performed by the processor based on at least one vehicle parameter, in particular speed, steering angle, or parking maneuvering of the vehicle.

8. A method of controlling a temperature of the processor according to claim 1, the method comprising following steps:
capturing images by an image capturing device;
processing, by the processor, the images captured by the image capturing device;
detecting, by a temperature detecting unit, a temperature of the processor to provide temperature data;
receiving, by a control unit, the temperature data containing the temperature of the processor detected by the temperature detection unit; and
controlling, by the control unit, at least one function performed by the processor based on the temperature data.

9. The method according to claim 8, wherein the controlling, by the control unit, further comprises: turning off the at least one function performed by the processor in an event when the temperature of the processor is above a threshold range.

10. The method according to claim 8, wherein the controlling, by the control unit, further comprises: turning on the at least one function performed by the processor in an event when the temperature of the processor is below a threshold range.

11. The method according to claim 8, wherein the at least one function performed by the processor is configured to be a framerate reduction, software algorithms, transition filters, or chromatic aberration correction.

12. A vehicle comprising the vision system according to claim 1.
